(19) United States
(12) Patent Application Publication
(10) Pub. No.: US 2006/0112262 A1
(43) Pub. Date: May 25, 2006

(54) Branch prediction of unconditionally executed branch instructions

(75) Inventor: Matthew Paul Elwood, Austin, TX (US)

Correspondence Address: NIXON & VANDERHYE, PC, 901 NORTH GLEBE ROAD, 11TH FLOOR, ARLINGTON, VA, 22203, US

(73) Assignee: ARM LIMITED, Cambridge (GB)

(21) Appl. No.: 10/994,179

(22) Filed: Nov. 22, 2004

(51) Int. Cl. G06F 9/00

(52) U.S. Cl. 712/240

(57) ABSTRACT

A data processing system 2 includes an instruction pipeline with a branch prediction mechanism. The branch prediction mechanism includes a branch history register 20 operating to store a value GHV which can be used to identify whether a newly encountered branch instruction is one which has been previously encountered. If the branch is not one which has previously been encountered, then a not taken prediction is made. This not taken prediction is applied to both conditional and unconditional branch instructions. The instruction set of the processor core 2 supports predication instructions which render unconditional branch instructions conditional.

### BACKGROUND OF THE INVENTION

1. Field of the Invention

This invention relates to the field of data processing systems. More particularly, this invention relates to the field of data processing systems having branch prediction mechanisms which operate to predict the outcome of branch instructions.

2. Description of the Prior Art

It is known to provide data processing systems with branch prediction mechanisms with the aim of improving processing performance by correctly fetching and supplying into an instruction pipeline the sequence of program instructions which will require execution as the program flow is followed. The consequences of misprediction in terms of wasted processing time performing a pipeline flush and refill are severe and accordingly it is known to provide sophisticated multi-layered branch prediction mechanisms. Branches can be considered to be my instruction which results in a non-sequential program flow.

Branch prediction mechanisms typically deal with conditional branch instructions which may or may not be executed and result in a branch depending upon the outcome of preceding processing. Accordingly, at the time at which the branch instruction is fetched into the instruction pipeline to be followed by subsequent instructions, it is not known if the conditions required for execution of that branch instruction will be satisfied. The branch prediction mechanisms seek to deal with this by making a prediction, e.g. based upon past behaviour.

Not all branch instructions within an instruction set need be conditional branch instructions. It is expected that unconditional branch instructions will be executed and result in a branch (unexpected interrupts, or the like, may occasionally prevent execution). Thus, the system can assume that such branches are always taken.

In order to increase the flexibility of instruction sets it has been proposed to add predication instructions which can serve to predicate otherwise unconditional instructions. This can help to give many of the advantages of conditional instruction sets whilst avoiding the increase in instruction bit space required if all instructions are made conditional.

### SUMMARY OF THE INVENTION

Viewed from one aspect the present invention provides apparatus for processing data, said apparatus having:

an instruction fetch unit operable to fetch one or more program instructions starting from an instruction fetch address into an instruction pipeline; and

a branch predictor operable to generate a prediction indicative of whether or not a branch instruction fetched into said instruction pipeline will be taken and so result in a non-sequential change in said instruction fetch address, said instruction fetch unit being responsive to said prediction to generate a next instruction fetch address; wherein

said branch predictor comprises:

at least one branch history register operative to store a branch history value indicative of whether or not a predetermined number of previously fetched branch instructions were predicted taken or predicted not taken;

a branch instruction identifying circuit operable to identify both conditionally executed branch instructions and unconditionally executed branch instructions within said instruction pipeline and to generate a branch history value element for updating said branch history value in respect of a branch instruction for which no prediction based upon a previous fetch of said branch instruction is available; and said program instructions fetched to said instruction pipeline include one or more predication instructions operable to predicate a predetermined number of following program instructions.

Counter-intuitively, the present technique recognises that unconditional branch instructions may be used to help improve the accuracy of the prediction mechanisms normally applied to conidtional branch instructions. Unconditional branch instructions can be rendered conditional by predication instructions and then the behaviour of these predicated unconditional branch instructions use or more accurately identify previous behaviour in the branch history mechanism.

Whilst it will be appreciated that predication instructions can take a variety of different forms, in preferred embodiments predication instructions comprises if-then-else instructions operable to specified conditions under which a predetermined number of following instructions will or will not be executed.

Whilst the branch predictor can be formed in a variety of different ways, preferred embodiments use a branch target buffer operable to store branch instruction address data identifying a plurality of previously encountered branch instructions that were taken together with associated branch target address data. Preferred embodiments also use a branch history buffer addressed by a branch history value (address value bits or other items) to store a branch prediction based upon an identifying preceding sequence of branch taken predictions.

Viewed from another aspect the present invention provides a method of processing data, said method comprising the steps of:

fetching one or more program instructions starting from an instruction fetch address into an instruction pipeline; and

generating a prediction indicative of whether or not a branch instruction fetched into said instruction pipeline will be taken and so result in a non-sequential change in said instruction fetch address, said instruction fetch unit being responsive to said prediction to generate a next instruction fetch address; wherein

said step of generating a prediction comprises:

storing at least one branch history value indicative of whether or not a predetermined number of previously fetched branch instructions were predicted taken or predicted not taken;

identifying both conditionally executed branch instructions and unconditionally executed branch instructions within said instruction pipeline and to generate a branch history value element for updating said branch history value in respect of a branch instruction for which no prediction based upon a previous fetch of said branch instruction is available; and

wherein said program instructions fetched to said instruction pipeline include one or more predication instructions operable to predicate a predetermined number of following program instructions.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates a processor core including an instruction pipeline;

FIG. 2 schematically illustrates a branch predictor for use within the instruction fetch stage of an instruction pipeline; and

FIG. 3 is a flow diagram schematically illustrating the branch prediction performed.

### DESCRIPTION OF THE PREFERRED EMBODIMENTS

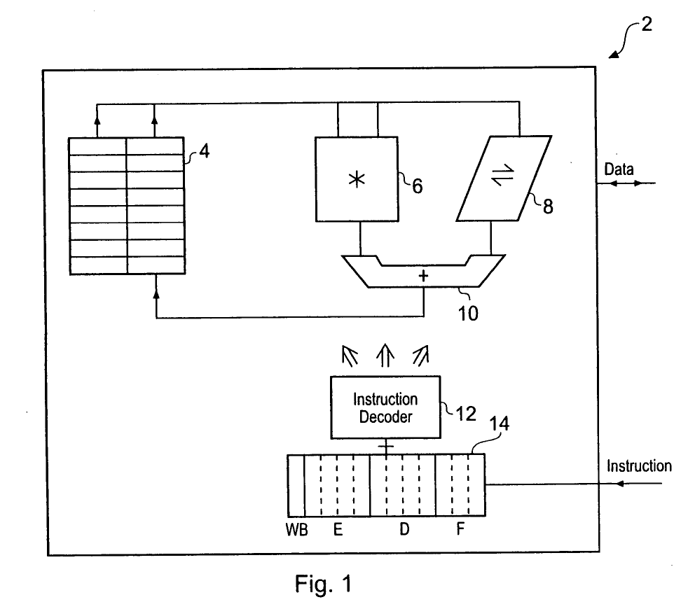

FIG. 1 schematically illustrates a data processing apparatus in the form of a processor core 2. This processor core is formed as part of an integrated circuit and may share the same integrated circuit package with many other components, such as memories, DSPs, input/output circuits and the like. As illustrated, the processor core includes a register bank 4, a multiplier 6, a shifter 8 and an adder 10 which operate under control of signals produced by an instruction decoder 12 to perform data processing operations specified by program instructions fetched from a memory. An instruction pipeline 14 includes fetch stages F, decode stages D, execute stages E and a writeback stage WB. It will be appreciated that such instruction pipelines are in themselves well known in this technical field and will not be described further herein. It will be appreciated that a multiple issue pipeline could also be used. It will also be appreciated that the processor core 2 will typically include many other circuit elements which have been omitted from FIG. 1 for the sake of clarity. The overall operation of the processor core 2 illustrated in FIG. 1 is that program instructions are fetched from a memory and then executed as they pass along the instruction pipeline 14 to perform desired data processing operations upon data values using the various circuit elements 4, 6, 8, 10 illustrated in FIG. 1, as well as other circuit elements.

The program instructions fetched into the instruction pipeline 14 include branch instructions which serve to specify a discontinuity in program memory address location of a current program instruction to be fetched. Such branch instructions are known in the field of data processing apparatus as a way of controlling the program flow to follow other than a purely sequential path through the program. Branch instructions may be both conditional and unconditional. Conditional branch instructions are ones which themselves specify conditions controlling whether or not they will be executed depending upon the outcome of previously executed program instructions or possibly an operation combined with the branch instruction itself. As an example, a previous program instruction may perform a compare operation and, if the result of that compare operation indicates that the operands were equal then the branch concerned will be executed, but otherwise the branch instruction will not be executed. Such instructions are common in program loops. As well as supporting conditional branch instructions of this form, the processor core 2 also supports unconditional branch instructions. These unconditional branch instructions may form part of the same instruction set as the conditional branch instructions or alternatively may be in a separate instruction set which is supported by the processor core 2. Unconditional branch instructions are executed resulting in the specified change in program flow without regard for the outcome of previous data processing instructions (assuming these do not result in exceptions, interrupts and the like which force a non-sequential program flow and a consequent pipeline flush). It has also been propose in the Thumb-2 instruction set of ARM processors to include predication instructions which serve to render conditional one or more following instructions. Thus, a predication instruction can render a following branch instruction conditional. This conditional behaviour of intrinsically unconditional branch instructions renders these intrinsically unconditional branch instructions a worthwhile subject for the branch prediction mechanisms employed within the fetch stages F of the instruction pipeline 14 in order to improve prediction accuracy. Unconditional branch encodings typically give more instruction bit space for encoding other information and yet these may be made to behave conditionally when required by the use of predication instructions.

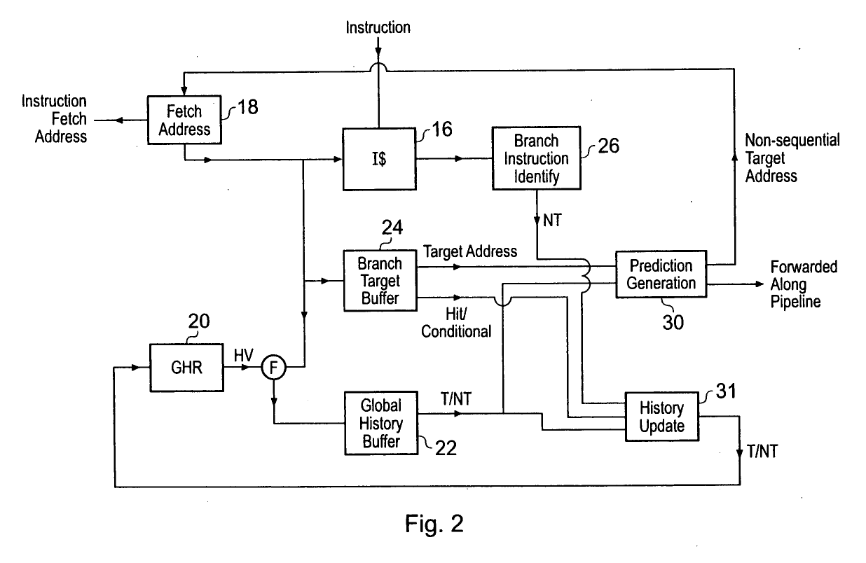

FIG. 2 schematically illustrates a branch prediction mechanism within the fetch stages F of the instruction pipeline 14. Instructions are fetched into an instruction cache 16 from fetch addresses stored within a fetch address register 18. The fetch address register 18 stores a program counter value indicating the address to be associated with those program instructions when they are issued into the instruction pipeline 14. The instruction cache 16 is a small cache locally storing few program instructions which are issued sequentially or in parallel into the pipeline. Parallel issue presupposes a superscalar architecture for the processor core 2. The fetch addresses (program counter values) associated with the program instructions are passed down the instruction pipeline 14 together with the program instructions to which they relate.

As will be appreciated by those skilled in this field, the fetch stages F prefetches instructions and issues these into the instruction pipeline 14 before the final outcome of preceding instructions has been determined. Accordingly, the sequence of instructions fetched is based upon a prediction of the program flow that will be followed. Program flow is normally sequential, but branch instructions can alter this an accordingly it is important that branch instructions be identified and a prediction made as to whether or not that branch will be followed.

The branch prediction mechanism illustrated in FIG. 2 includes a global history register 20 which stores the taken or not taken outcome of previously encountered branch instructions within the program flow. This pattern of outcomes is used to identify a branch instruction that is encountered and to address into a global history buffer 22 where a prediction of taken or not taken for that encountered branch instruction can be stored. The addressing into the global history buffer 22 may also be dependent upon part of the instruction address. The global history register 20 is then updated with a history update circuit 31 with the outcome that has been predicted and can be used to identify the next encountered branch instruction. Efforts to update the global history value early improve prediction accuracy. If the prediction made turns out to be incorrect, then the global history register value 20 is subsequently corrected and the prediction stored within the global history buffer 22 amended. The prediction can be multi-levelled, e.g. strongly taken, weakly taken, weakly not taken and strongly not taken in order to provide a degree of prediction hystersis if desired.

Another aspect of branch prediction is being able to determine as rapidly as possible, or at least predict, the branch target address of an encountered branch instruction. The branch target address may not be determined at the time that the branch instruction concerned is fetched, but if that branch instruction has previously been encountered, then a good prediction is that the branch target will be the same as previously used by that branch instruction. Accordingly, a branch target buffer 24 serves to cache branch target addresses of taken branches. These cached branch target addresses can then be used to enable the prefetch unit to start fetching instructions from the branch target location based upon the predicted branch target address.

A branch instruction identifying circuit 26 serves to identify branch instructions fetched in the program instruction stream based upon a partial hardwired decoding thereof. These branch instructions include both conditional and unconditional branch instructions. The branch instructions identifying circuit 26 also makes a default not taken indication for encountered branch instructions of either form which is used if the other branch prediction mechanisms do not indicate that the branch instruction concerned has previously been encountered. The identification of branch instructions by the branch instructions identifying circuit 26 is also used to trigger the action of the global history register 20, global history buffer 22 and branch target buffer 24 to perform their various lookups and updates in dependence upon the instruction fetch address stored within the instruction fetch address register 18 as previously discussed. A prediction generation circuit 30 issues branch taken prediction into the instruction pipeline.

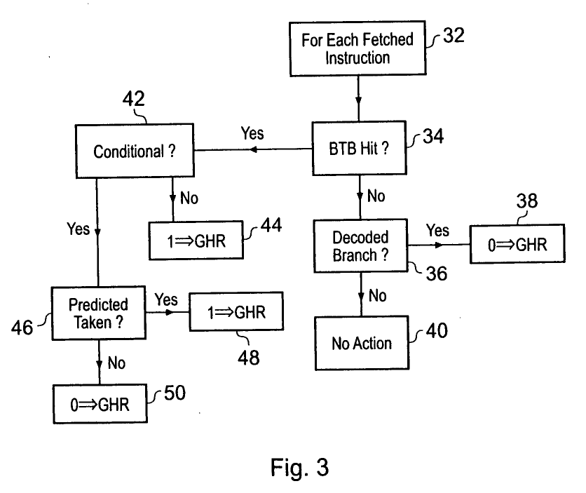

FIG. 3 is a flow diagram schematically illustrating the branch prediction performed. At step 32 the following process is initiated for each fetched instruction. Step 34 determines whether there is a hit within the branch target buffer. If there is no hit, then processing proceeds to step 36 at which it is determined whether or not the instruction concerned is a branch instruction (either conditional or unconditional). If the instruction is a branch instruction, then step 38 shifts a zero value (corresponding to branch not taken) into the global history register. Otherwise no action is taken at step 40.

If the determination at step 34 was that a hit occurred in the branch target buffer, then step 42 determines whether or not the fetched instruction is conditional. If the fetched instruction is not conditional, then step 44 shifts a value of 1 into the global history register corresponding to a branch taping indication. If the determination at step 44 was that the instruction is conditional, then processing proceeds to step 46 at which a prediction is made based upon the global history register value looked up in the global history buffer as to whether or not the branch will be taken. If the branch is predicted taken, then a 1 is written into the global history register at step 48. If the branch is predicted as not taken then a 0 is written to the global history register at step 50.

For every fetch, a lookup is also made in the branch target buffer 24. If there is a hit within the branch target buffer 24, then this indicates that this branch was previously taken and its target address is cached within the branch target buffer 24 and so is available for use.

The branch instruction identifying circuit 26 also produces a default not taken prediction which is used to update the global history register. This default not taken prediction is applied to both conditional and unconditional branch instructions which are detected. In the case of unconditional branch instructions, it would normally be expected that these would be executed and accordingly the branch taken. The default prediction of not taken at first sight seems in conflict with this. However, if that unconditional branch instruction has not previously been encountered, as indicated by a miss in the branch target buffer 24, then no branch target address will be cached for it and so a pipeline stall and flush will in any case be incurred. However, if the default not taken prediction is correct for the predicted unconditional branch instruction, then the uninterrupted program flow of sequential instructions will be followed and the prefetching will proceed without a stall. This arrangement is able to deal with unconditional branch instructions which are rendered conditional by preceding predication instructions. In the case where these predication instructions result in the unconditional branch instructions not being executed and the branch not being taken, then this behaviour is correctly predicted on the first pass by the default not taken prediction which is generated. If this prediction is incorrect, then the same penalty is incurred as would be incurred if no prediction were made. The global history register is also repaired.

It will be appreciated that the predication instructions can take a variety of forms and these include if-when-else instructions which effectively predicate a predetermined number of following instructions which may or may not be skipped depending upon the state of the condition codes when that predication instruction is executed. A branch predictor may be a global branch predictor or a local branch predictor depending upon the particular implementation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

I claim:

1. Apparatus for processing data, said apparatus having:
an instruction fetch unit operable to fetch one or more program instructions starting from an instruction fetch address into an instruction pipeline; and
a branch predictor operable to generate a prediction indicative of whether or not a branch instruction fetched into said instruction pipeline will be taken and so result in a non-sequential change in said instruction fetch address, said instruction fetch unit being responsive to said prediction to generate a next instruction fetch address; wherein
said branch predictor comprises:
at least one branch history register operative to store a branch history value indicative of whether or not a predetermined number of previously fetched branch instructions were predicted taken or predicted not taken;
a branch instruction identifying circuit operable to identify both conditionally executed branch instructions and unconditionally executed branch instructions within said instruction pipeline and to generate a branch history value element for updating said branch history value in respect of a branch instruction for which no prediction based upon a previous fetch of said branch instruction is available; and
said program instructions fetched to said instruction pipeline include one or more predication instructions operable to predicate a predetermined number of following program instructions.

2. Apparatus as claimed in claim 1, wherein said predication instructions comprise if-then-else instructions operable to specify conditions under which said predetermined number of following instruction will or will not be executed.

3. Apparatus as claimed in claim 1, wherein a predication instruction is operable to render an unconditional branch instruction to behave as a conditional branch instruction.

4. Apparatus as claimed in claim 1, wherein said branch predictor comprises a branch taken buffer operable to store branch instruction address data identifying a plurality of previously encountered branch instructions that were taken together with associated branch target address data indicative of respective next instruction fetch addresses to be used by said instruction fetch unit when a previously encounter branch instruction is fetched into said instruction pipeline.

5. Apparatus as claimed in claim 1, wherein said branch predictor comprises a branch history buffer addressed by said branch history value and operable to store a branch taken prediction or a branch not taken prediction for a fetched branch instruction based upon an identifying preceding sequence of branch taken predictions and branch not taken predictions.

6. Apparatus as claimed in claim 1, wherein said branch predictor is one of a global branch predictor or a local branch predictor.

7. Apparatus as claimed in claim 1, wherein said branch history value element is a prediction not taken prediction value.

8. A method of processing data, said method comprising the steps of:
fetching one or more program instructions starting from an instruction fetch address into an instruction pipeline; and
generating a prediction indicative of whether or not a branch instruction fetched into said instruction pipeline will be taken and so result in a non-sequential change in said instruction fetch address, said instruction fetch unit being responsive to said prediction to generate a next instruction fetch address; wherein
said step of generating a prediction comprises:
storing at least one branch history value indicative of whether or not a predetermined number of previously fetched branch instructions were predicted taken or predicted not taken;
identifying both conditionally executed branch instructions and unconditionally executed branch instructions within said instruction pipeline and to generate a branch history value element for updating said branch history value in respect of a branch instruction for which no prediction based upon a previous fetch of said branch instruction is available; and
wherein said program instructions fetched to said instruction pipeline include one or more predication instructions operable to predicate a predetermined number of following program instructions.

9. A method as claimed in claim 8, wherein said predication instructions comprise if-then-else instructions operable to specify conditions under which said predetermined number of following instruction will or will not be executed.

10. A method as claimed in claim 8, wherein a predication instruction is operable to render an unconditional branch instruction to behave as a conditional branch instruction.

11. A method as claimed in claim 8, wherein said branch predictor comprises a branch taken buffer operable to store branch instruction address data identifying a plurality of previously encountered branch instructions that were taken together with associated branch target address data indicative of respective next instruction fetch addresses to be used by said instruction fetch unit when a previously encounter branch instruction is fetched into said instruction pipeline.

12. A method as claimed in claim 8, wherein said branch predictor comprises a branch history buffer addressed by said branch history value and operable to store a branch taken prediction or a branch not taken prediction for a fetched branch instruction based upon an identifying preceding sequence of branch taken predictions and branch not taken predictions.

13. A method as claimed in claim 8, wherein said branch predictor is one of a global branch predictor or a local branch predictor.

14. A method as claimed in claim 8, wherein said branch history value element is a prediction not taken prediction value.
